(19) United States
(12) Patent Application Publication
(10) Pub. No.: US 2026/0009814 A1
(43) Pub. Date: Jan. 8, 2026

(54) SYSTEMS AND METHODS FOR DIRECTING FLUID

(71) Applicant: MicrofluidX Ltd, Stevenage (GB)

(72) Inventors: James DAVIES, Stevenage (GB); Antoine ESPINET, London (GB)

(21) Appl. No.: 19/268,341

(22) Filed: Jul. 14, 2025

Related U.S. Application Data
(63) Continuation of application No. PCT/GB2024/050091, filed on Jan. 15, 2024.
(60) Provisional application No. 63/439,267, filed on Jan. 16, 2023.

(51) Int. Cl. G01N 35/10

(52) U.S. Cl. CPC G01N 35/1002; G01N 35/1016; G01N 35/1065; G01N 2035/1023

(57) ABSTRACT

The present disclosure provides systems, devices, and methods for distributing reagents between multiple bioprocessing devices. In some cases, a valve apparatus described herein comprises: (a) a first manifold comprising one or more reagent ports configured to receive a reagent; (b) a second manifold comprising one or more fluid channels; and (c) a third manifold comprising (i) one or more input ports configured to direct said reagent to a bioprocessing device or (ii) one or more output ports configured to receive a fluid from said bioprocessing device; wherein said second manifold is disposed between said first manifold and said third manifold along an axis, wherein said first manifold or said second manifold is configured to rotate around said axis from a first closed position to a first open position.

### CROSS-REFERENCE

This application is a continuation of International Patent Application No. PCT/GB2024/050091, filed Jan. 15, 2024, which claims priority to U.S. Provisional Patent Application No. 63/439,267, filed on Jan. 16, 2023, each of which is incorporated herein by reference in entirety.

### BACKGROUND

Ex-vivo processing of cells or other biological components for the research and development of cell therapy treatments requires multiple fluid reagents to be transported to multiple separate bioreactors, all while maintaining a sterile environment to prevent the cells becoming infected by microbial growth. Thus, there is a need for systems and methods for choosing and selectively transporting reagents to a predetermined or selected bioprocessing chamber, without breaching sterility.

### SUMMARY

The systems and methods described herein disclose a valve system that can fluidically connect multiple inputs to multiple outputs for selective distribution of a fluid within a system. For example, the systems and methods described herein can be used to automatically select an input reagent and deliver that selected input reagent to the appropriate output bioreactor based on a desired process sequence.

In an aspect, provided herein is a valve apparatus, comprising: (a) a first manifold comprising one or more reagent ports configured to receive a reagent; (b) a second manifold comprising one or more fluid channels; and (c) a third manifold comprising (i) one or more input ports configured to direct the reagent to a bioprocessing device or (ii) one or more output ports configured to receive a fluid from the bioprocessing device; wherein the second manifold is disposed between the first manifold and the third manifold along an axis, wherein the first manifold or the second manifold is configured to rotate around the axis from a first closed position to a first open position, wherein when in the first open position, the one or more reagent ports are fluidically connected to the one or more fluid channels, and wherein the third manifold or the second manifold is configured to rotate around the axis from a second closed position to a second open position, wherein when in the second open position, the one or more input ports or the one or more output ports are fluidically connected to the one or more fluid channels.

In some cases, each of the one or more reagent ports are configured to receive a unique reagent. In some cases, each of the one or more reagent ports are fluidically connected to a reagent container. In some cases, each of the one or more input ports are fluidically connected to a unique bioprocessing device. In some cases, each of the one or more output ports are fluidically connected to a unique bioprocessing device. In some cases, the third manifold further comprises a drain port. In some cases, the fluid received from the bioprocessing device comprises waste fluid. In some cases, the drain port is configured to remove the waste fluid from the valve apparatus. In some cases, the first manifold is located above the second manifold, and the second manifold is located above the third manifold.

In some cases, the second manifold further comprises one or more access holes configured to couple to a pump, and the access holes are fluidically connected to the one or more fluid channels. In some cases, a first access hole of the one or more access holes is configured to couple to a first pump, and a second access hole of the one or more access holes is configured to couple to a second pump. In some cases, the first access hole is fluidically connected to a first fluid channel of the one or more fluid channels, and the second access hole is fluidically connected to a second fluid channel of the one or more fluid channels. In some cases, when in the second open position, (i) the first fluid channel is fluidically connected to an input port of the one or more input ports, and (ii) the second fluid channel is fluidically connected to an output port of the one or more input ports.

In some cases, the first manifold, the second manifold, and the third manifold are circular in shape. In some cases, each of the one or more reagent ports are located at an equal distance from a center of the first manifold. In some cases, the one or more reagent ports are located equidistant from each other. In some cases, each of the one or more input ports are located at an equal distance from a center of the third manifold. In some cases, the one or more input ports are located equidistant from each other. In some cases, each of the one or more output ports are located at an equal distance from a center of the third manifold. In some cases, the one or more output ports are located equidistant from each other.

In some cases, when in the first closed position, the one or more reagent ports are fluidically sealed from the one or more fluid channels. In some cases, the first manifold comprises a first alignment notch, and the second manifold comprises a second alignment notch. In some cases, when in the first open position, the first alignment notch and the second alignment notch align with each other.

In some cases, when in the second closed position, the one or more input ports or the one or more output ports are fluidically sealed from the one or more fluid channels. In some cases, the second manifold comprises a second alignment notch, and the third manifold comprises a third alignment notch. In some cases, when in the second open position, the second alignment notch and the third alignment notch align with each other.

In some cases, the second manifold further comprises a sterilization fluid port, and the sterilization fluid port is configured to receive a sterilization fluid. In some cases, the sterilization fluid comprises steam. In some cases, the sterilization fluid is configured to sterilize interior surfaces of the valve apparatus. In some cases, the sterilization fluid is configured to displace a residual fluid from the valve apparatus.

In another aspect, provided herein is a method, comprising: (a) providing a valve comprising (i) a first manifold comprising one or more reagent ports configured to receive a reagent, (ii) a second manifold comprising one or more fluid channels; and (iii) a third manifold comprising one or more input ports configured to direct the reagent to a bioprocessing device, wherein the second manifold is disposed between the first manifold and the third manifold along an axis; (b) introducing the reagent into the one or reagent ports; (c) rotating the first manifold or the second manifold around the axis from a first closed position to a first open position, wherein when in the first open position, the reagent enters the fluid channels; and (d) rotating the third manifold or the second manifold around the axis from a second closed position to a second open position, wherein when in the second open position, the reagent enters the bioprocessing device.

In some cases, each of the one or more reagent ports is configured to receive a unique reagent. In some cases, each of the one or more reagent ports is fluidically connected to a reagent container. In some cases, each of the one or more input ports is fluidically connected to a unique bioprocessing device.

In some cases, the first manifold is located above the second manifold, and the second manifold is located above the third manifold.

In some cases, third manifold further comprises one or more output ports configured to

receive a waste fluid from the bioprocessing device. In some cases, each of the one or more output ports is fluidically connected to a unique bioprocessing device. In some cases, the third manifold further comprises a drain port. In some cases, the drain port is configured to remove the waste fluid from the valve.

In some cases, the second manifold further comprises one or more access holes configured to couple to a pump, and the access holes are fluidically connected to the one or more fluid channels. In some cases, a first access hole of the one or more access holes is configured to couple to a first pump, and a second access hole of the one or more access holes is configured to couple to a second pump. In some cases, the first access hole is fluidically connected to a first fluid channel of the one or more fluid channels, and the second access hole is fluidically connected to a second fluid channel of the one or more fluid channels.

In some cases, when in the second open position, (i) the reagent enters the bioprocessing device through the first fluid channel, and (ii) the second fluid channel receives the fluid from the bioprocessing device.

In some cases, the first pump and second pump are operated at the same flow rate such that a total volume of fluid within the bioprocessing device remains constant. In some cases, the first pump is operated at a higher flow rate than the second pump rate such that a total volume of fluid within the bioprocessing device increases. In some cases, the first pump is operated at a lower flow rate than the second pump rate such that a total volume of fluid within the bioprocessing device decreases.

In some cases, the first manifold, the second manifold, and the third manifold are circular in shape.

In some cases, when in the first closed position, the one or more reagent ports are fluidically sealed from the one or more fluid channels. In some cases, the first manifold comprises a first alignment notch, and the second manifold comprises a second alignment notch. In some cases, when in the first open position, the first alignment notch and the second alignment notch align with each other. In some cases, when in the second closed position, the one or more input ports or the one or more output ports are fluidically sealed from the one or more fluid channels.

In some cases, the second manifold comprises a second alignment notch, and the third manifold comprises a third alignment notch. In some cases, when in the second open position, the first alignment notch and the second alignment notch align with each other.

In some cases, the second manifold further comprises a sterilization fluid port, and prior to (a), a sterilization fluid is introduced to the valve through the sterilization fluid port. In some cases, the sterilization fluid comprises steam. In some cases, the sterilization fluid is configured to sterilize interior surfaces of the valve. In some cases, the sterilization fluid is configured to displace a residual fluid from the valve.

In another aspect, provided herein is a microfluidic system, comprising: (a) one or more reagent containers; (b) one or more bioprocessing devices; and (c) a valve apparatus, comprising (i) a first manifold comprising one or more reagent ports fluidically connected to the one or more reagent containers, (ii) a second manifold comprising one or more fluid channels, and (iii) a third manifold comprising one or more input ports and one or more output ports fluidically connected to the one or more bioprocessing devices, wherein the one or more input ports are configured to direct a reagent to the one or more bioprocessing devices, and wherein the one or more output ports are configured to receive a fluid from the one or more bioprocessing devices; wherein the second manifold is disposed between the first manifold and the third manifold along an axis, wherein the first manifold or the second manifold is configured to rotate around the axis from a first closed position to a first open position, wherein when in the first open position, the one or more reagent ports are fluidically connected to the one or more fluid channels; wherein the third manifold or the second manifold is configured to rotate around the axis from a second closed position to a second open position, wherein when in the second open position, the one or more input ports or the one or more output ports are fluidically connected to the one or more fluid channels.

In some cases, each of the one or more reagent ports is fluidically connected to a unique reagent container of the one or more reagent containers. In some cases, each of the one or more input ports is fluidically connected to a unique bioprocessing device of the one or more bioprocessing devices. In some cases, each of the one or more output ports is fluidically connected to a unique bioprocessing device of the one or more bioprocessing devices.

In some cases, the third manifold further comprises a drain port. In some cases, the fluid received from the bioprocessing device comprises waste fluid. In some cases, the drain port is configured to remove the waste fluid from the microfluidic system.

In some cases, the first manifold is located above the second manifold, and the second manifold is located above the third manifold.

In some cases, the second manifold further comprises one or more access holes configured to couple to a pump, and the access holes are fluidically connected to the one or more fluid channels. In some cases, a first access hole of the one or more access holes is configured to couple to a first pump, and a second access hole of the one or more access holes is configured to couple to a second pump. In some cases, the first access hole is fluidically connected to a first fluid channel of the one or more fluid channels, and the second access hole is fluidically connected to a second fluid channel of the one or more fluid channels.

In some cases, when in the second open position, (i) the first fluid channel is fluidically connected to an input port of the one or more input ports, and (ii) the second fluid channel is fluidically connected to an output port of the one or more input ports.

In some cases, when in the first closed position, the one or more reagent ports are fluidically sealed from the one or more fluid channels. In some cases, the first manifold comprises a first alignment notch, and the second manifold comprises a second alignment notch. In some cases, when in the first open position, the first alignment notch and the second alignment notch align with each other.

In some cases, when in the second closed position, the one or more input ports or the one or more output ports are fluidically sealed from the one or more fluid channels. In some cases, the second manifold comprises a second alignment notch, and the third manifold comprises a third alignment notch. In some cases, when in the second open position, the first alignment notch and the second alignment notch align with each other.

In some cases, the second manifold further comprises a sterilization fluid port, and the sterilization fluid port is configured to receive a sterilization fluid. In some cases, the sterilization fluid comprises steam. In some cases, the sterilization fluid is configured to sterilize interior surfaces of the valve apparatus. In some cases, the sterilization fluid is configured to displace a residual fluid from the valve apparatus.

In another aspect, provided herein is a kit, comprising: (a) a valve apparatus, comprising (i) a first manifold comprising one or more reagent ports fluidically connected to the one or more reagent containers, (ii) a second manifold comprising one or more fluid channels fluidically connected to one or more access holes, and (iii) a third manifold comprising one or more input ports and one or more output ports fluidically connected to the one or more bioprocessing devices, wherein the one or more input ports are configured to direct a reagent to the one or more bioprocessing devices, and wherein the one or more output ports are configured to receive a fluid from the one or more bioprocessing devices; and (b) one or more pumps, wherein the one or more pumps are configured to releasably couple to the one or more access holes of the second manifold; wherein the second manifold is disposed between the first manifold and the third manifold along an axis, wherein the first manifold or the second manifold is configured to rotate around the axis from a first closed position to a first open position, wherein when in the first open position, the one or more reagent ports are fluidically connected to the one or more fluid channels; wherein the third manifold or the second manifold is configured to rotate around the axis from a second closed position to a second open position, wherein when in the second open position, the one or more input ports or the one or more output ports are fluidically connected to the one or more fluid channels.

In another aspect, provided herein is a non-transitory computer readable medium comprising machine-executable code that, upon execution by one or more computer processors, implements a method for directing a reagent through a valve, the method comprising: (a) introducing the reagent to a valve, wherein the valve comprises (i) a first manifold comprising one or more reagent ports configured to receive the reagent, (ii) a second manifold comprising one or more fluid channels; and (iii) a third manifold comprising one or more input ports configured to direct the reagent to a bioprocessing device, wherein the second manifold is disposed between the first manifold and the third manifold along an axis; (b) flowing the reagent through the one or reagent ports; (c) rotating the first manifold or the second manifold around the axis from a first closed position to a first open position, wherein when in the first open position, the reagent enters the fluid channels; and (d) rotating the third manifold or the second manifold around the axis from a second closed position to a second open position, wherein when in the second open position, the reagent enters the bioprocessing device.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 illustrates an exploded view of a valve system, in accordance with some embodiments.

FIG. 2 illustrates an upper manifold of a valve system, in accordance with some embodiments.

FIG. 3 illustrates a top-view orientation of a selection manifold of a valve system, in accordance with some embodiments.

FIG. 4 illustrates a bottom-view orientation of a selection manifold of a valve system, in accordance with some embodiments.

FIG. 5 illustrates a lower manifold of a valve system, in accordance with some embodiments.

FIG. 6 illustrates a top-view orientation of a valve system with an upper manifold located on top, in accordance with some embodiments.

FIG. 7 illustrates a bottom-view orientation of a valve system with a lower manifold located on bottom, in accordance with some embodiments.

FIG. 8 illustrates a top-view orientation of a valve system with an upper manifold located on top of a selection manifold, in accordance with some embodiments.

FIG. 9 illustrates a cross-sectional view of a valve showing fluid connections between upper, selection, and lower manifolds, in accordance with some embodiments.

FIG. 10 illustrates a cross-sectional view of a valve showing an integrated steam system in an unpressurized state, in accordance with some embodiments.

FIG. 11 illustrates a cross-sectional view of a valve showing an integrated steam system in a pressurized state, in accordance with some embodiments.

FIG. 12 schematically illustrates a computer system that is programmed or otherwise configured to implement methods provided herein.

### DETAILED DESCRIPTION

While various embodiments have been shown and described herein, it will be obvious to those skilled in the art that such embodiments are provided by way of example only. Numerous variations, changes, and substitutions can occur to those skilled in the art without departing from the disclosure. It should be understood that various alternatives to the embodiments of the disclosure described herein can be employed.

Whenever the term “about,” “at least,” “greater than,” or “greater than or equal to” precedes the first numerical value in a series of two or more numerical values, the term “about,” “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Overview

The devices, methods, and systems described herein are directed to a valve apparatus that can be operated in conjunction with a microfluidic system. When performing tests in a microfluidic system, it can be advantageous to run multiple experiments. Additionally, it can be beneficial to run each individual experiment multiple times. For example, experiments can be performed in duplicate or triplicate. To achieve this, a valve system can fluidically connect to multiple individual and separate bioreactors. Process parameters can be varied within each separate bioreactor throughout the duration of an experiment. To achieve the desired process paraments within each bioreactor, several different types of reagents may need to be delivered to a particular bioreactor during an experiment. Additionally, other fluids can be introduced to a particular bioreactor during an experiment, which can include, but is not limited to, transduction vectors, pluronic solutions, and potentially a mixture of several reagents. The systems and methods described herein may also be used to combine one or more reagents, each in a desired or predetermined concentration, to create a reagent mixture. Furthermore, a solution containing cells to be cultured may be contained within a single sterile bottle or bag, and the cells can be introduced into individual bioreactors using the valve system described herein. Therefore, cells can be uniformly distributed to each and every bioreactor.

### Valve

The valve systems described herein can be used to fluidically connect one or more reagents with one or more bioprocessing chambers. For example, the valves and valve systems described herein may be fluidically connected to one, two, three, four, five, six, seven, eight, nine, or more reagent containers. A reagent container may comprise a tank or a bag, for example. For example, the valves and valve systems described herein may be fluidically connected to one, two, three, four, five, six, seven, eight, nine, or more bioprocessing chambers. A bioprocessing chamber can be a bioreactor or a cassette.

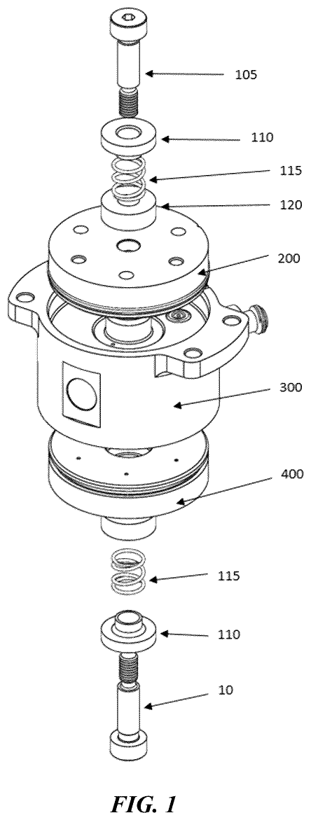

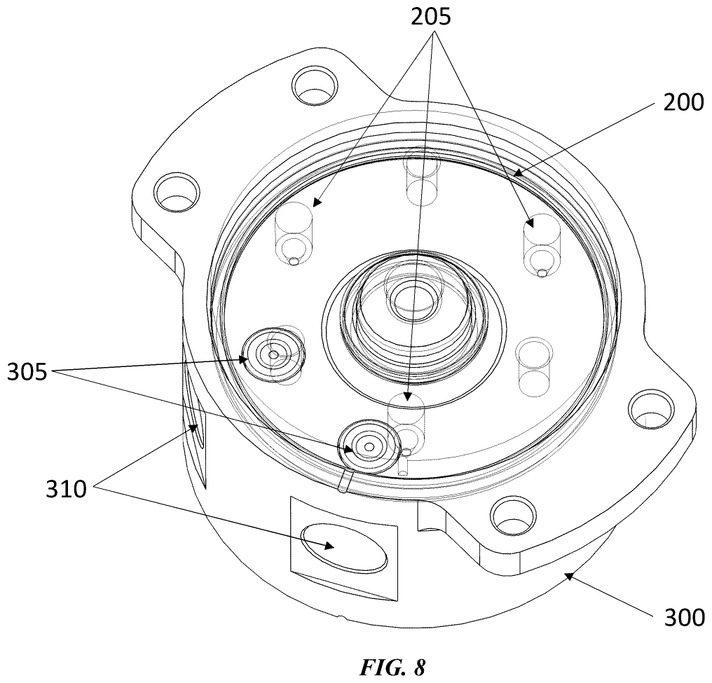

As illustrated in FIGS. 1-8, a valve may have three reagent ports that connect to three bioprocessing chambers. FIG. 1 illustrates an exploded view of a valve system as described herein. A valve system can comprise three manifolds: an upper manifold 200, a selection manifold 300, and a lower manifold 400. The upper manifold 200 can axially assemble into the selection manifold 300. The lower manifold 400 can also axially assemble into the selection manifold 300. The manifolds may be connected by one or more shoulder bolts 105. The shoulder bolt 105 may be used to connect a first manifold to a second manifold via a spring bearing 110, a manifold spring 115, and a spring spacer 120. In some cases, an upper manifold is connected to a selection manifold by a first shoulder bolt 105. In some cases, a lower manifold is connected to a selection manifold by a first shoulder bolt 105.

The upper, selection, and lower manifolds can be stacked on top of each other along an axis. The upper, selection, and lower manifolds can be concentric with each other. In some cases, the manifolds may be circular in shape. In some cases, the upper manifold 200 and the lower manifold 400 are able to rotate around the axis relative to a stationary selection manifold 300. In some cases, the selection manifold 300 is able to rotate around the axis relative to the upper manifold 200 and lower manifold 400. A stationary manifold can be fixed to the machine and not move axially or rotationally. In some cases, the manifold springs 115 are compression springs. The compression spring 115 can exert a force on the upper manifold 200 and/or the lower manifold 400. A selection manifold 300 may have raised edges along its perimeters, both on the top and bottom. The compression force exerted against the upper manifold 200 and the lower manifold 400 may result in a face seal between the manifolds. This face seal, may result in a fluid seal between the upper manifold 200, selection manifold 300, and lower manifold 400. The face seal can prevent fluid from exiting the valve apparatus when flowing between manifolds. In some cases, raised edges of the selection manifold form a radial seal between the selection manifold and an upper or lower manifold. This radial seal can prevent a sterilization fluid from exiting the valve apparatus. The spring bearing 110 can allow the manifold spring 115 to freely rotate with the manifolds without binding. The spring spacers 120 can preload the manifold springs 115 such that an adequate sealing force is present in the face seals.

As described herein, an upper manifold can be fluidically connected to one or more reagent containers or vessels. Reagents can comprise, for example, balanced salt solutions, buffers, detergents, chelators, materials or substances that promote or facilitate cell adhesion, or any other fluids that may be fed into a bioprocessing chamber or bioreactor. In some cases, the one or more reagent containers are connected to the upper manifold by one or more reagent lines. In some cases, different combinations of reagents can be mixed together prior to being fed to a valve system as described herein.

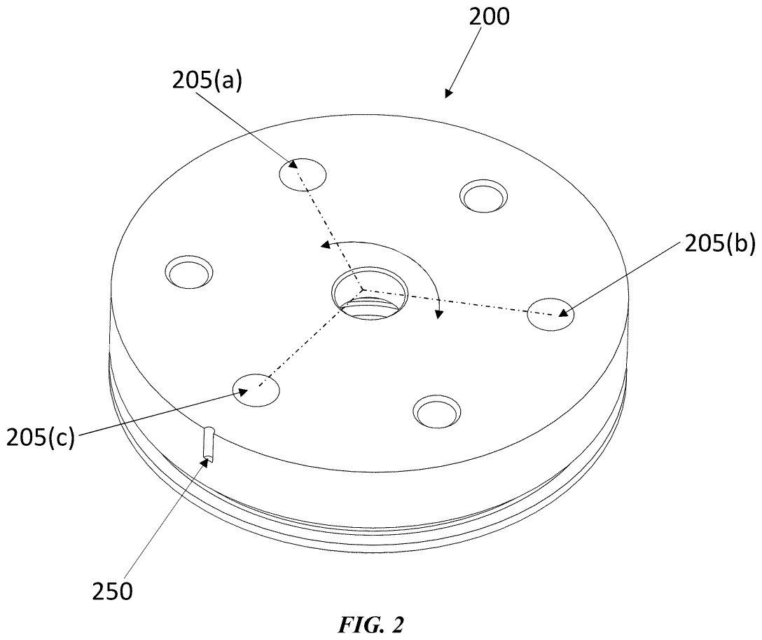

As shown in FIG. 2, an upper manifold can comprise one or more reagent ports 205. In some cases, each reagent port is fluidically connected to a different reagent container. For example, reagent port 205(a) may be connected to a first reagent (Reagent A). Reagent port 205(b) may be connected to a second reagent (Reagent B). Reagent port 205(c) may be connected to a third reagent (Reagent C). The number of reagent ports present on a valve system can be a function of how many reagents are required for a specific bioprocess. If less than the maximum number of reagents is required for a process, a reagent port 205 can remain unused (i.e., the unused reagent port 205 is not fluidically connected to any reagent container). In some cases, the ports on an upper manifold can be fluidically connected to one or more bioprocessing chambers (rather than reagent tanks). An upper manifold can be configured to rotate around an axis as shown by the arrow in FIG. 2. In some cases, the upper manifold can be manually or automatically rotated such that a desired reagent port 205 in the upper manifold lines up with a fluid channel in the selection manifold 300 located below the upper manifold. Upper manifold 200 may include an alignment notch 250. This alignment notch 250 can be used to indicate or mark the amount of rotation an upper manifold has undergone as compared to a baseline position. In some cases, when two manifolds are fluidically connected or open, their alignment notches may align.

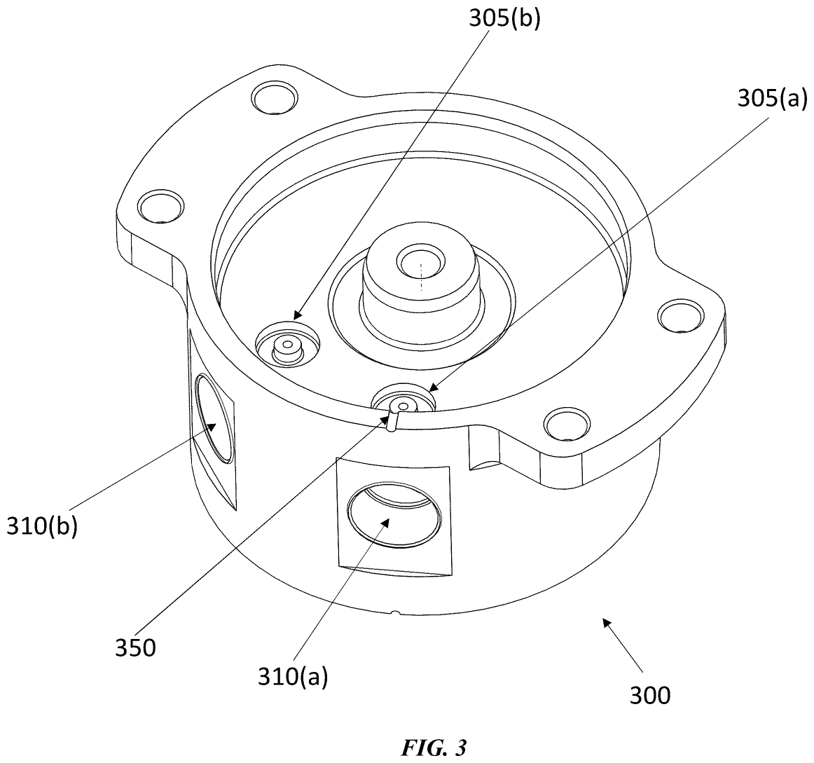

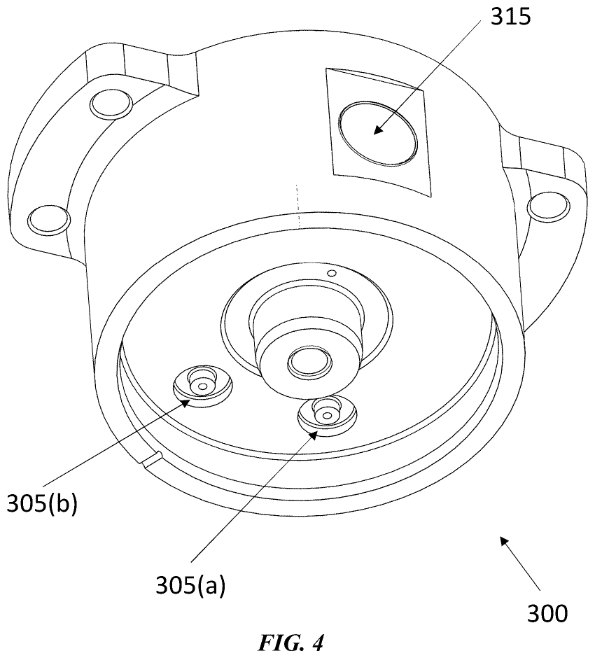

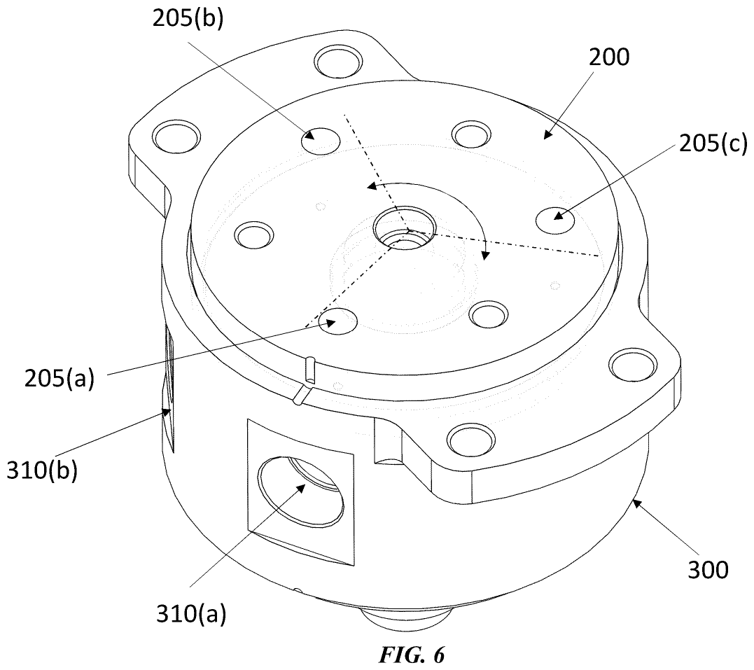

As shown in FIG. 1 and FIG. 6, an upper manifold 200 can be located on top of a selection manifold 300. FIG. 3 and FIG. 4 show alternate views of an isolated selection manifold 200 that is not connected to an upper or lower manifold. A selection manifold can comprise one or more fluid channels 305. The fluid channels 305 may extend throughout the length of the selection manifold 300 such that they can be accessed at the top of the selection manifold (depicted in FIG. 3) and at the bottom of the selection manifold (depicted in FIG. 4). In some cases, fluid channels 305 are configured to direct a fluid from the top of the selection manifold to the bottom of the selection manifold. In some cases, fluid channels 305 are configured to direct a fluid from the bottom of the selection manifold to one or more access holes. Fluid channels 305 may be accessed via one or more access holes 310. Access holes 310 can be configured to fluidically connect fluid channels 305 to one or more pumps. In some cases, a pump forms a fluid tight seal with an access hole 310. In some cases, fluid flowing through fluid channels 305 enters flows through one or more pumps. In some cases, fluid flowing through fluid channels 305 can remain for a period of time within a fluid chamber in a pump. Each fluid channel may be accessed via its own access hole. For example, as shown in FIG. 3, a first fluid channel 305a can be accessed via a first access hole 310(a). A second fluid channel 305(b) can be accessed via a second access hole 310(b). This can allow two pumps to independently control the fluid flow in each fluid channel. For example, a first pump can control fluid flow in fluid channel 305(a) via access hole 310(a), and a second pump can control fluid flow in fluid channel 305(b) via access hole 310(b).

Selection manifold 300 may include an alignment notch 350. This alignment notch 350 can be used to indicate or mark the amount of rotation an upper manifold or lower manifold has undergone as compared to a baseline position. For example, at a baseline position, the alignment notch on the upper manifold 250 and the alignment notch on the selection manifold 350 may be aligned. The upper manifold 200 can then be rotated around an axis while the selection manifold 300 remains stationary (or vice versa). After such a rotation, the alignment notches may no longer align with each other. The angle between formed between the axis of rotation and the two alignment notches 250 and 350 can indicate the amount of rotation the rotating manifold has undergone.

As shown in FIG. 6, an upper manifold 200 can rotate relative to said selection manifold 300 such that one or more reagent ports 205 align with one or more fluid channels 305. In some cases, when a manifold is aligned with a fluid channel above or below it such that the manifold and the fluid channel are fluidically connected, the valve is in an open position. In some cases, when a manifold is misaligned with a fluid channel above or below it such that the manifold and the fluid channel are fluidically sealed, the valve is in a closed position. In some cases, a manifold can rotate about 15° between a closed and an open position. In some cases, a manifold can rotate greater than 15° between a closed and an open position. In some cases, a manifold can rotate less than 15° between a closed and an open position. In some cases, a manifold can rotate about 5°, 10°, 12.5°, 14°, 15°, 16°, 17.5°, 20°, or 25° between a closed and an open position. If a reagent port 205 is aligned with a fluid channel 305, fluid can flow through the reagent port 205 into the fluid channel 305. Alignment can include full or partial alignment of the reagent port with the fluid channel. Upper manifold 200 can continue to rotate such that no reagent ports 205 align with the fluid channels 305, thus resulting in no fluid flow between the upper manifold and selection manifold. Depending on the rotation of upper manifold 200, different reagent ports may be fluidically connected to the selection manifold 300. As such, by rotating the upper manifold (either manually or automatically), a user can selectively determine which reagents flow through said selection manifold (and eventually to a bioprocessing device).

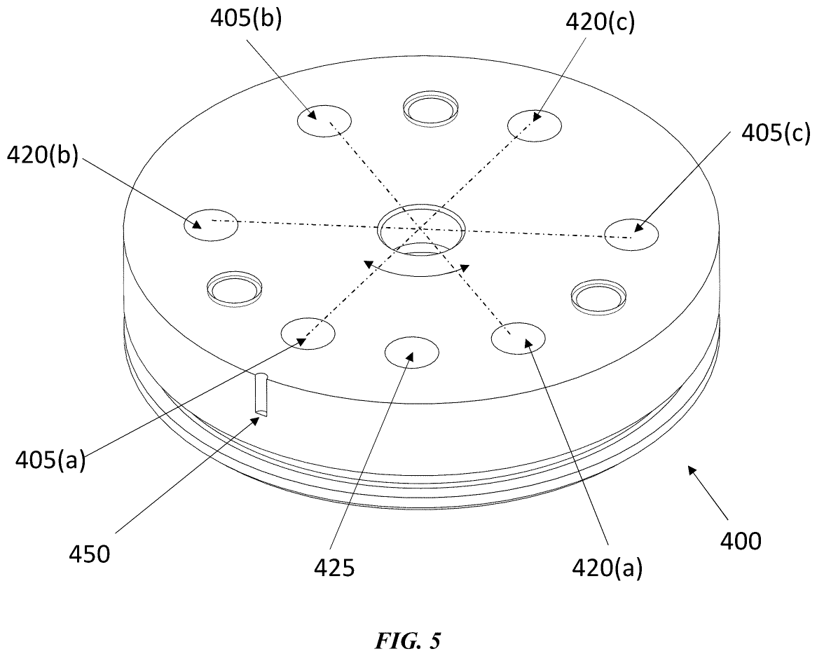

As shown in FIG. 1, a lower manifold 400 can be located below a selection manifold 300. FIG. 5 illustrates an example of a lower manifold as described herein. A lower manifold can comprise one or more input ports 405. Input ports 405 can be configured to direct a reagent to a bioprocessing device (such as a bioreactor or cassette). In some cases, each input port 405 is fluidically connected to a different bioprocessing device. For example, input port 405(a) may be fluidically connected to a first bioprocessing device (Bioreactor A). Input port 405(b) may be fluidically connected to a second bioprocessing device (Bioreactor B). Input port 405(c) may be fluidically connected to a third bioprocessing device (Bioreactor C).

A lower manifold can comprise one or more output ports 420. Output ports 420 can be configured to receive a fluid from a bioprocessing device (such as a bioreactor or cassette). In some cases, each output port 420 is fluidically connected to a different bioprocessing device. For example, output port 420(a) may be fluidically connected to a first bioprocessing device (Bioreactor A). Output port 420(b) may be fluidically connected to a second bioprocessing device (Bioreactor B). Output port 420(c) may be fluidically connected to a third bioprocessing device (Bioreactor C).

The number of input and output ports present on a valve system can be a function of how many bioprocessing chambers are required for a specific bioprocess. If less than the maximum number of bioprocessing chambers are required for a process, an input port 405 or output port 420 can remain unused. For example, if an experiment or process only requires two bioreactors (Bioreactor A and B), input port 405(c) and output port 420(c) may not be used. In some cases, the ports on an lower manifold can be fluidically connected to one or more reagent vessels (rather than bioprocessing chambers).

A lower manifold can be configured to rotate around an axis as shown by the arrow in FIG. 5. In some cases, the lower manifold can be manually or automatically rotated such that a desired input port 405 in the lower manifold lines up with a fluid channel 305 located above the lower manifold. In some cases, when a manifold is aligned with a fluid channel above or below it such that the manifold and the fluid channel are fluidically connected, the valve is in an open position. In some cases, when a manifold is misaligned with a fluid channel above or below it such that the manifold and the fluid channel are fluidically sealed, the valve is in a closed position. In some cases, a manifold can rotate about 15° between a closed and an open position. In some cases, a manifold can rotate greater than 15° between a closed and an open position. In some cases, a manifold can rotate less than 15° between a closed and an open position. In some cases, a manifold can rotate about 5°, 10°, 12.5°, 14°, 15°, 16°, 17.5°, 20°, or 25° between a closed and an open position. In some cases, the lower manifold can be manually or automatically rotated such that a desired output port 405 in the lower manifold lines up with a fluid channel 305 located above the lower manifold. Lower manifold 400 may include an alignment notch 450. This alignment notch 450 can be used to indicate or mark the amount of rotation the lower manifold has undergone as compared to a baseline position. For example, at a baseline position, the alignment notch on the lower manifold 450 and the alignment notch on the selection manifold 350 may be aligned. The lower manifold 400 can then be rotated around an axis while the selection manifold 300 remains stationary (or vice versa). After such a rotation, the alignment notches may no longer align with each other. The angle between formed between the axis of rotation and the two alignment notches 350 and 450 can indicate the amount of rotation the rotating manifold has undergone.

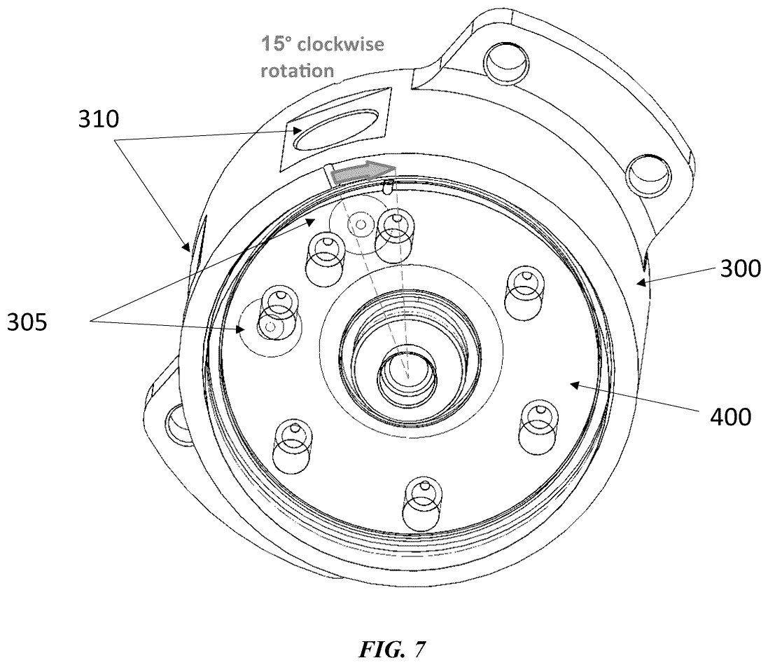

As shown in FIG. 7, a lower manifold 400 can rotate relative to said selection manifold 300 such that one or more input ports 405 or output ports 420 align with one or more fluid channels 305. If an input port 405 is aligned with a fluid channel 305, fluid can flow from the fluid channel 305 into the input port 405. If an out port 420 is aligned with a fluid channel 305, fluid can flow from the outlet port 420 into the fluid channel 305. Alignment can include full or partial alignment of the reagent port with the fluid channel. Lower manifold 400 can continue to rotate such that no input ports 405 or output ports 420 align with the fluid channels 305, thus resulting in no fluid flow between the lower manifold and selection manifold. Depending on the rotation of lower manifold 200, different bioprocessing device may be fluidically connected to the selection manifold 300. As such, by rotating the lower manifold (either manually or automatically), a user can selectively determine which bioprocessing device to deliver reagents to or which bioprocessing device to receive fluid from.

A lower manifold can comprise one or more drain ports 425. A drain port 425 can be fluidically connected to a drain or waste container. In some cases, waste fluid from a bioprocessing device can enter the valve through an output port 420. This waste fluid can then exit the valve through a drain port 425. In some cases, the waste fluid that enters the valve through an output port 420 can be directed through a fluid channel 305. From there, the waste fluid can be directed to a pump via an access hole 310. While the waste fluid remains, the lower manifold 400 can be rotated such that the fluid channel aligns with the drain port 425. Once rotated, the waste fluid can exit the pump, flow through the fluid channel 305, and exit the valve via drain port 425.

To deliver a volume of reagent to a cassette and remove a volume of fluid from the cassette, the following steps can be followed. The steps can occur sequentially. Some steps can take concurrently. The steps can be achieved by electromechanical actuation of the valve under software control. The following example refers to FIGS. 2-7. As an example, the following steps can be used to deliver a first reagent (Reagent A) to a first cassette (Bioreactor A). However, the process can be used to deliver any reagent to any bioreactor. Additionally, the steps can be repeated sequentially to deliver additional reagents to the same bioreactor (for example, Reagent B to Bioreactor A), deliver the same reagent to a different bioreactor (for example, Reagent A to Bioreactor B), or deliver a different reagent to a different bioreactor (for example, Reagent B to Bioreactor B), or any combination thereof.

Step 1a: Upper manifold 200 can be rotated such that reagent port 205(a) on the upper manifold, which is fluidically connected to a reagent vessel containing Reagent A, is aligned with fluid channel 305(a).

Step 1b: As step la occurs, the lower manifold 400 can rotate relative to the selection manifold 300 such that so that all input ports 405 and output ports 420 in the lower manifold are misaligned with the fluid channels 305. Therefore, fluid will not be able to flow from the fluid channels 305 into the input ports 405 or output ports 420.

Step 2: A first pump (Pump 1) can be connected to fluid channel 305(a) via access hole 310(a). Pump 1 can draw Reagent A via reagent port 205(a) through fluid channel 305(a) and into the pumping chamber of Pump 1. Because the lower manifold was rotated in Step 1b, at this stage, no fluid can enter the lower manifold 400.

Step 3a: Upper manifold 200 can rotate clockwise or anti-clockwise to misalign all reagent ports 205 with all fluid channels 305. Therefore, fluid will not be able to flow from the reagent ports 205 into the fluid channels 305. Meanwhile, Reagent A can remain in the pumping chamber of Pump 1.

Step 3b: Lower manifold 400 can rotate relative to the selection manifold 300 such that so that the inlet port for Bioreactor A 405(a) aligns with fluid channel 305(a), and the outlet port for Bioreactor A 420(a) aligns with fluid channel 305(b).

Step 4: Pump 1 can push Reagent A into the inlet port for Bioreactor A 405(a) via fluid channel 305(a). Pump 2 can draw fluid from the outlet port for Bioreactor A 420(a) through fluid channel 305(b). In some cases, Pump 1 and Pump 2 can perform these steps simultaneously. Both pumps can operate at the same flow rate, resulting in a constant volume of fluid in Bioreactor A. Pump 1 can operate at a higher flow rate than Pump 2, resulting in an increasing volume of fluid in Bioreactor A. Pump 2 can operate at a higher flow rate than Pump 1, resulting in a decreasing volume of fluid in Bioreactor A.

Step 5: The upper manifold can remain in the same position as Step 3b and Step 4. The lower manifold 400 can rotate such that fluid channel 305(b) aligns with the drain port 425.

Step 6: Pump 2 pushes fluid via fluid channel 305(b) into the drain port 425. Fluid that exits through drain port 425 can go to a drain or waste container, for example.

Step 7: Upper manifold 200 and lower manifold 400 can rotate back to a baseline position, ready for the next operation.

Throughout the example described above, there are times when the reagent ports 205 in the upper manifold 200 or the inlet/outlet ports 405 and 420 in the lower manifold 400 are not fluidically connected with either fluid channel 305 in the selection manifold 300. This can be achieved by rotating the upper manifold 200 and/or the lower manifold 400 until the holes/ports in these parts become misaligned with the fluid channels 305. If the angle of misalignment is sufficient for the holes or ports to be outside of the fluid footprint of the face seals present in the selection manifold 300, then fluid communication is prevented for the hole/port in question. When either the upper manifold 200 and/or the lower manifold 400 are rotated once again to bring the holes/ports back into alignment with the fluid channels 305, fluid communication can resume. Thus, the valve function of opening and closing a hole/port can be achieved through either aligning or misaligning the holes/ports in the upper and lower manifold with the through holes of the selection manifold. Whether flow occurs once alignment is achieved for a particular hole/port can be dependent on whether the corresponding pump is operated. Pumps can be operated to control the direction of fluid flow by either drawing fluid into the pumping chamber or dispensing fluid from the pumping chamber.

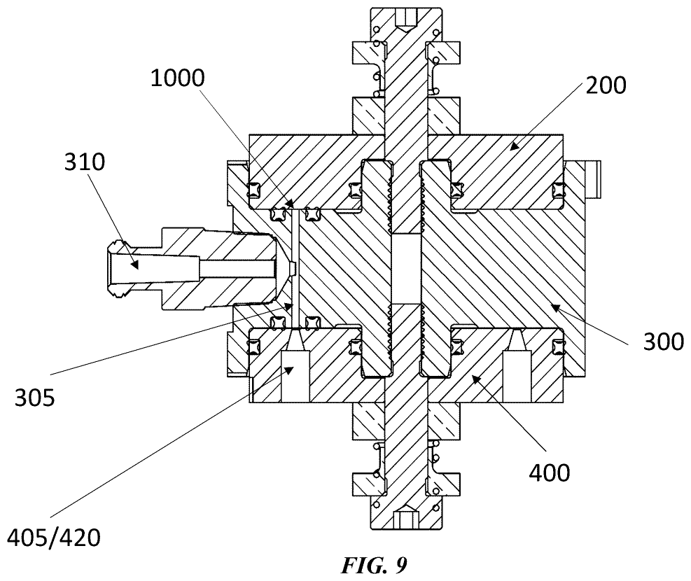

This valve switching is illustrated in the cross-sectional view shown in FIG. 9. In some cases, as shown in FIG. 9, the upper manifold 200 has been rotationally positioned relative to the selection manifold 300 such that the reagent port 205 (not pictured) does not align with fluid channel 305, resulting in no fluid connection between the upper manifold and the selection manifold. This is shown in FIG. 9 at point 1000, where the upper portion of the fluid channel 305 contacts a solid face of the upper manifold. In FIG. 9, fluid channel 305 is aligned with an outlet port present in the lower manifold. This could be an inlet port 405 or an outlet port 420. Therefore, fluid can flow between a pump and a bioprocessing device, via access port 310. Because upper manifold 200 is sealed from the fluid channel 305, no fluid can enter the upper manifold 200.

### Integrated Pumping

The many-to-many switching function of the valves described herein can be incorporated with a positive displacement pumping system to facilitate the displacement or transport of fluid. A pump can be integrated with the valves described herein to transport fluid from one input reagent container to a particular bioreactor at a defined moment during the experiment. In some cases, a positive displacement pump is used. Positive displacement pumps can include piston pumps and peristaltic pumps, for example. A positive displacement pump can incorporate a pumping chamber that can hold a volume of fluid for a certain amount of time. Depending on the input and output flow rate of fluid to the pumping chamber, the volume of the fluid within the pumping chamber can change during operation of the pump. In some cases, the volume and flow rate displaced by the pump is controlled and varied. In some cases, two or more pumps can be used simultaneously. The two or more pumps can be of identical, similar, or of differing types. In some cases, two or more pumps can be integrated into one many-to-many valve.

The integrated pumping described herein can separately control the volume of fluid entering the inlet port of a bioreactor and the volume of fluid leaving the outlet port of the bioreactor. By being able to separately control the flowrate of fluid into and out of an individual bioreactor, the liquid fluid level within a bioreactor can be controlled at any particular moment in time. If the flowrate of fluid coming into the bioreactor (controlled by a first pump) is greater than the flowrate of fluid leaving the bioreactor (controlled by a second pump), the volume of fluid contained in the bioreactor will increase. Conversely, if the flowrate of fluid leaving a bioreactor is greater than the flowrate of fluid entering the bioreactor, the volume of fluid contained in the bioreactor will decrease. If for instance, the flowrate of fluid leaving the bioreactor is zero and the flowrate entering is 1 mL/min then over a period of one minute the volume of fluid in the bioreactor will increase by 1 mL. Conversely, if the flowrate of fluid entering bioreactor is 0 mL and the volume leaving 1 mL/min then over a period of one minute the volume of fluid in the bioreactor will decrease by 1 mL. The valve and fluid distributions described herein can be integrated with two or more positive displacement pumps. In some cases, the valve is fluidically connected to both a fluid inlet and a fluid outlet of a bioreactor, therefor the volume of fluid in each bioreactor can be controlled by varying the operation of these two pumps. There are certain parts of the cell culture process when it is desirable to either raise or lower the fluid level in the cassette, and the pumping system described can achieve both.

By incorporating two pumps that can operate individually into the valve system described therein, the volume of fluid within any specific bioreactor can be controlled. The desired bioreactor can be chosen by switching the valve as described herein. In addition to fluid being pumped to and from one or more bioreactors, the valves described herein can be used to pump reagents in and out of any reagent container. The desired reagent container can be chosen by switching the valve as described herein. Therefore, the systems and methods described herein can result in a flexible fluid transportation system in which only few pumps are required to displace and transport fluid to any part of a closed fluid circuit. This can minimize the size, complexity and overall cost of the system. Additionally, this can maximize reliability by reducing the number of mechanical elements (such as pumps) required to transport fluid.

At a given time, a pump can be configured to either draw or dispense fluid. One pump can switch between performing both functions. For example, at a first time point, Pump 1 can be operated to dispense fluid into a cassette. At a second time point, Pump 1 can be operated to draw fluid from the same cassette. This is advantageous as it creates a very flexible arrangement with the possibility of any fluid port operating as either an input port or an output port. For example, an input port 405 can be reconfigured to operate as an output port 420 by changing the operation of the pump attached thereto.

If the inlet and outlet ports on a bioprocessing device are arranged at different heights, the fluid height in the cassette can be accurately controlled to two desired height positions. For example, an inlet/outlet port to a cassette that is fluidically connected to Pump 2 can be located ¾ up the height of a cassette. Another inlet/outlet port to a cassette that is fluidically connected to Pump 1 can be located ¼ up the height of the cassette. If for instance, the height of fluid in the cassette is above ¾, Pump 2 can be set to draw fluid from the cassette until the liquid level drops to the height of Pump 2 (¾ the height of the cassette). Further drawing of fluid by Pump 2 will draw gas from above the liquid level and the liquid level will remain at the set height. If it is desired to lower the fluid height to the second desired height, ¼, Pump 1 can be set to draw fluid from the cassette until the liquid level drops to the height of Pump 1 (¼ the height of the cassette). Further drawing of fluid by Pump 1 will draw gas from above the liquid level and the liquid level will remain at the set height. As the set heights will be defined accurately by features manufactured into the cassette, the liquid level can therefore be accurately controlled geometrically without the need for incorporating liquid level sensing into the system.

Expelled fluid from an outlet of a bioreactor can be displaced into one of the pumps described herein. This fluid drawn from the bioreactor can then be sent for downstream processing through an outlet port of the valves described herein. For example, fluid drawn from the bioreactor can be sent to a metabolite analyzer for analysis of the supernatant fluid. Because of cost and size constraints, the amount of downstream equipment (a metabolite analyzer, for example) can be limited. Therefore, it is beneficial to be able to collect and send fluid from any bioreactor to one (or a small number of) downstream analyzer, like a metabolite analyzer.

### Sterilization

As described above a closed sterile circuit can be formed for the entirety of the system, including all the fluids, gas, and cells to be cultured. The volume of a bioreactor can be divided between a liquid fluid volume containing cells, above which is a headspace containing a mixture of gases required to culture the cells. The internal volume of a bioreactor is fixed and does not change over time. How much fluid verses gas is present in a particular bioreactor at any moment of the experiment can be dependent on the stage of the cell culture. Generally, when perfusing cells, the level of fluid in the bioreactor should be maintained constant. There are other moments during an experiment, such as transducing the cells with a viral vector, when it may be desirable to have a different fluid level in the bioreactor. For example, it may be desirable for the bioreactor to have more liquid containing the cells and less gas volume or vice versa.

As described previously, an important requirement of the system is to maintain sterility of the closed sterile circuit throughout the duration of the experiment until the cultured cells are harvested and stored. The fluid system can be made up of single use disposable components and reusable components. Components that are designed to be reusable can include bioreactors, valves (including the valves described herein), and the fluid lines connecting the valve to reagents and/or bioreactors. In some cases, bioreactors may be disposable. Utilizing reusable components over single-use components can minimize the cost of performing an experiment and also the time required to set up the system prior to commencing an experiment. However, in order to maintain a sterile circuit, reusable parts of the system require sterilizing and cleaning between experimental runs.

The valve described herein can include an integrated sterilizing system. As shown in FIG. 4, selection manifold 300 can include a sterilization port 315. A sterilization fluid can be fed in through sterilization port 315 to clean and sterilize the valve and fluid lines connected thereto. In some cases, the sterilization fluid comprises steam. In some cases, the sterilization fluid is under pressure. In some cases, the sterilizing fluid is steam. The sterilizing fluid can be pressurized steam that is introduced to the sterilizing box at a pressure that relates to the temperature of the steam of at least 121° C. In some cases, a steam generator creates the steam using a supply of water and heat. In some cases, the steam is saturated steam. In some cases, the steam is superheated steam. The sterilization fluid can be a gas or a liquid. In some cases, the sterilization fluid is hydrogen peroxide liquid or vapour, ethylene oxide gas, or a combination thereof.

When introduced to pressurized steam, axial displacement of the upper and lower manifolds can occur, resulting in the pressurized steam being distributed around the internal surfaces of the valve, as well as any other internal surfaces that contact the fluid (such as interior surfaces of pumps and fluid lines). The pressurized steam can displace residual fluid from the valve and fluid pumps, entering the fluid lines connected to the valve, where it can then be flushed from the system via an exhaust port. Therefore, pressurized steam can be used to clear any residual fluid from the valve, pumps, and fluid lines that is left in the system at the end of the experimental run.

After the residual fluid has been flushed from the system, the pressurized steam can then sterilize the internal surfaces of the valve and pumps. The surfaces that are sterilized can include all surfaces that contact the fluid and cells when an experiment is being performed. This sterilizing process can be performed at the end of an experiment and again prior to commencing the next experiment. Steam at a temperature of at least 121° C. can sterilize any microbes that may be present on the internal surfaces of the valve, pump and reusable lines.

The period of time required for sterilizing to achieve a log 6 kill of microbes is a function of the temperature of the steam. A common sterilizing temperature for autoclaves to operate at is 121° C., with a typical period of exposure of 20 minutes. It may be desirable to have a shorter sterilizing cycle than this to minimize down-time between experimental runs, so a user may wish to use a sterilizing temperature of greater than 121° C.

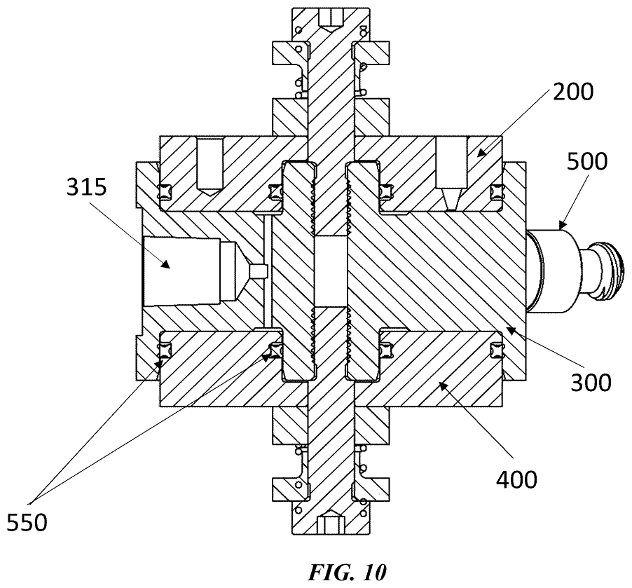

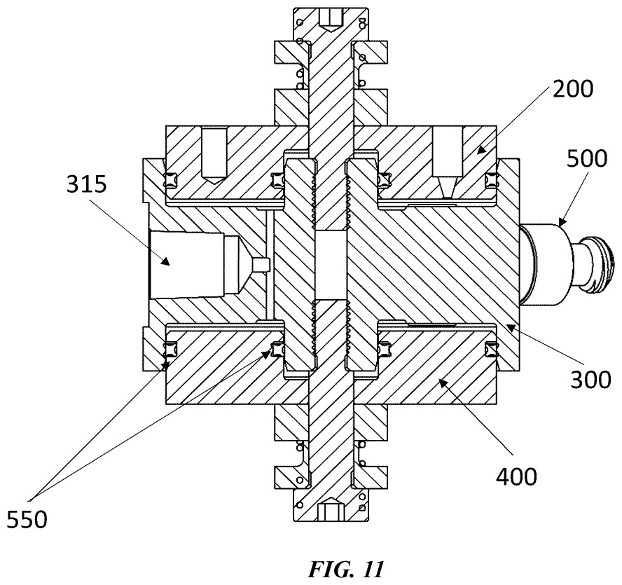

FIG. 10 and FIG. 11 show a cross section of the steam system in both an unpressurised (FIG. 10) and pressurized (FIG. 11) state. As previously discussed, the upper manifold 200 and the lower manifold 400 can seal against the selection manifold 300 due to the force applied from the manifold springs 115, which can be compression springs and in a preloaded state. Fluid sealing can be achieved by axial face seals between the three manifold components. When no steam pressure is applied, as shown in FIG. 10, the seals can be energized due to the manifold springs 115. To clean the valve and lines from fluid and to sterilize the valve, pressurized steam can be applied to sterilization port 315. Because the steam can be in fluid communication with the upper manifold 200 and lower manifold 400 via the steam transfer hole 500, the pressure from the steam can axially displace the upper manifold 200 and the lower manifold 400. Fluid Seals 550 can form a fluid tight seal between the upper and lower manifolds and the selection manifold, therefore preventing the pressurized steam from escaping to atmosphere. The pressure of the steam acting against the surface of the upper and lower manifolds can generate an axial force that pushes the upper and lower manifolds away from the selection manifold. When this steam force is equal in magnitude to the preload force from the manifold springs, a further increase in pressure can cause the upper and lower manifolds to be displaced vertically away from the selection manifold. This continues until the spring spacers 120 contact the spring bearings 110 at which point no further displacement occurs. This condition is shown in FIG. 11. As the upper and lower manifolds are displaced vertically, contact will be lost between the face seals between the selection manifold and the upper and lower manifolds. The vertical displacement of the upper and lower manifolds can be approximately 1 mm. In some cases, vertical displacement can be about 0.1 mm, 0.5 mm, 1 mm, 2.5 mm, or 5 mm. Vertical displacement can be greater than 1 mm or less than 1 mm. Once the upper and lower manifolds have been displaced vertically, steam can fill the space between the manifolds. As such, steam can flow through all of the reagent and bioprocessing chamber fluid lines. The flow of the pressurized steam can flush residual fluid in the lines and around the valve, where the residual fluid can be transported to a waste container. Having axially displaced the Upper and Lower Manifolds from the Selection Manifold the pressurized steam can also enter the pumping chambers of any pumps fluidically connected to the valve system, thereby sterilizing the interior surfaces of the pumps and pumping chambers. The radial seals present between the upper and lower manifolds and the selection manifold can prevent the steam from escaping to atmosphere and thus allow the steam pressure and therefore temperature to increase. Once the steam has reached a temperature of at least 121° C., the steam pressure can be maintained for a time sufficient for sterilization to occur.

### Computer Systems

The valves and microfluidic systems described herein can be automatically operated by a device with electromechanical elements under software control. The rotation of the upper and lower manifolds can be achieved by pulleys coupled to the manifolds, which can be driven by toothed belts. Motion of the belts can be controlled by a stepper motor or servo, which can cause the pulleys to rotate. The rotation of the pulleys can rotate depending on which manifold is being driven at any moment. Other methods to achieve rotation of the upper and lower manifolds can include spur gears, a chain system, a worm gear, or a rack and pinion, or a combination thereof. The toothed belts driving the pulleys can be driven by second pulley wheels which are attached to a servo motors. The servo motors can incorporate an encoder which allows the servo and hence the pulleys, to be moved accurately to a specific angular position. By knowing the ratio of pulley sizes attached to the upper and lower manifolds and the pulleys attached to the servos, it is possible to accurately rotate the upper and lower manifolds via the servos to known positions so that specific ports can align with fluid channels in the selection manifold.

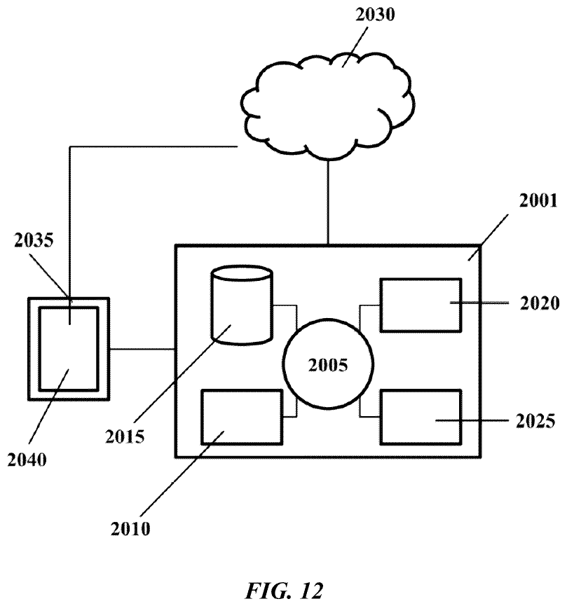

In an aspect, the present disclosure provides computer systems that are programmed or otherwise configured to implement methods of the disclosure, e.g., any of the subject methods for sterilization. Computer systems can be used to automate any method described herein. FIG. 12 shows a computer system 2001 that is programmed or otherwise configured to implement a method for fluid distribution through a valve. The computer system 2001 can be configured to, for example, rotate an upper or lower manifold, automate or control the amount of sterilization fluid that enters the valve, or direct flow of a reagent or bioprocessing fluid from a first fluid line to a second fluid line. The computer system 2001 can make these adjustments based on one or more user inputs or sensor readings. The computer system 2001 can be further configured to adjust the flow rate or operation of one or more pumps to control the fluid volume of a bioprocessing device. The computer system 2001 can be an electronic device of a user or a computer system that is remotely located with respect to the electronic device. The electronic device can be a mobile electronic device.

The computer system 2001 can include a central processing unit (CPU, also “processor” and “computer processor” herein) 2005, which can be a single core or multi core processor, or a plurality of processors for parallel processing. The computer system 2001 also includes memory or memory location 2010 (e.g., random-access memory, read-only memory, flash memory), electronic storage unit 2015 (e.g., hard disk), communication interface 2020 (e.g., network adapter) for communicating with one or more other systems, and peripheral devices 2025, such as cache, other memory, data storage and/or electronic display adapters. The memory 2010, storage unit 2015, interface 2020 and peripheral devices 2025 are in communication with the CPU 2005 through a communication bus (solid lines), such as a motherboard. The storage unit 2015 can be a data storage unit (or data repository) for storing data. The computer system 2001 can be operatively coupled to a computer network (“network”) 2030 with the aid of the communication interface 2020. The network 2030 can be the Internet, an internet and/or extranet, or an intranet and/or extranet that is in communication with the Internet. The network 2030 in some cases is a telecommunication and/or data network. The network 2030 can include one or more computer servers, which can enable distributed computing, such as cloud computing. The network 2030, in some cases with the aid of the computer system 2001, can implement a peer-to-peer network, which can enable devices coupled to the computer system 2001 to behave as a client or a server.

The CPU 2005 can execute a sequence of machine-readable instructions, which can be embodied in a program or software. The instructions can be stored in a memory location, such as the memory 2010. The instructions can be directed to the CPU 2005, which can subsequently program or otherwise configure the CPU 2005 to implement methods of the present disclosure. Examples of operations performed by the CPU 2005 can include fetch, decode, execute, and writeback.

The CPU 2005 can be part of a circuit, such as an integrated circuit. One or more other components of the system 2001 can be included in the circuit. In some cases, the circuit is an application specific integrated circuit (ASIC).

The storage unit 2015 can store files, such as drivers, libraries and saved programs. The storage unit 2015 can store user data, e.g., user preferences and user programs. The computer system 2001 in some cases can include one or more additional data storage units that are located external to the computer system 2001 (e.g., on a remote server that is in communication with the computer system 2001 through an intranet or the Internet).

The computer system 2001 can communicate with one or more remote computer systems through the network 2030. For instance, the computer system 2001 can communicate with a remote computer system of a user (e.g., an operator managing or monitoring the bioprocessing). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 2001 via the network 2030.

Methods as described herein can be implemented by way of machine (e.g., computer processor) executable code stored on an electronic storage location of the computer system 2001, such as, for example, on the memory 2010 or electronic storage unit 2015. The machine executable or machine readable code can be provided in the form of software. During use, the code can be executed by the processor 2005. In some cases, the code can be retrieved from the storage unit 2015 and stored on the memory 2010 for ready access by the processor 2005. In some situations, the electronic storage unit 2015 can be precluded, and machine-executable instructions are stored on memory 2010.

The code can be pre-compiled and configured for use with a machine having a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 2001, can be embodied in programming. Various aspects of the technology can be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which can provide non-transitory storage at any time for the software programming. All or portions of the software can at times be communicated through the Internet or various other telecommunication networks. Such communications, for example, can enable loading of the software from one computer or processor into another, for example, from a management server or host computer into the computer platform of an application server. Thus, another type of media that can bear the software elements includes optical, electrical and electromagnetic waves, such as used across physical interfaces between local devices, through wired and optical landline networks and over various air-links. The physical elements that carry such waves, such as wired or wireless links, optical links or the like, also can be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, can take many forms, including but not limited to, a tangible storage medium, a carrier wave medium or physical transmission medium. Non-volatile storage media including, for example, optical or magnetic disks, or any storage devices in any computer(s) or the like, can be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media can be involved in carrying one or more sequences of one or more instructions to a processor for execution.

The computer system 2001 can include or be in communication with an electronic display 2035 that comprises a user interface (UI) 2040 for providing, for example, a portal for an operator to monitor or track one or more steps or operations of the valve and pumping systems described herein. The portal can be provided through an application programming interface (API). A user or entity can also interact with various elements in the portal via the UI. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 2005. For example, the algorithm can be configured to, for example, rotate an upper or lower manifold, automate or control the amount of sterilization fluid that enters a valve, or direct flow of a reagent or bioprocessing fluid from a first fluid line to a second fluid line. In some embodiments, the algorithm can be further configured to adjust the flow rate or operation of one or more pumps to control the fluid volume of a bioprocessing device. The algorithm can make these adjustments based on one or more user inputs or sensor readings.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the disclosure are not limited to the specific depictions, configurations or relative proportions set forth herein which depend upon a variety of conditions and variables. It should be understood that various alternatives to the embodiments of the disclosure described herein can be employed in practicing the disclosure. It is therefore contemplated that the disclosure shall also cover any such alternatives, modifications, variations or equivalents. It is intended that the following claims define the scope of the invention and that methods and structures within the scope of these claims and their equivalents be covered thereby.

1. A valve apparatus, comprising:
(a) a first manifold comprising one or more reagent ports configured to receive a reagent;
(b) a second manifold comprising one or more fluid channels; and
(c) a third manifold comprising (i) one or more input ports configured to direct said reagent to a bioprocessing device or (ii) one or more output ports configured to receive a fluid from said bioprocessing device;
wherein said second manifold is disposed between said first manifold and said third manifold along an axis,
wherein said first manifold or said second manifold is configured to rotate around said axis from a first closed position to a first open position, wherein when in said first open position, said one or more reagent ports are fluidically connected to said one or more fluid channels, and
wherein said third manifold or said second manifold is configured to rotate around said axis from a second closed position to a second open position, wherein when in said second open position, said one or more input ports or said one or more output ports are fluidically connected to said one or more fluid channels.

2. The valve apparatus of claim 1, wherein each of said one or more reagent ports are configured to receive a unique reagent.

3. The valve apparatus of claim 1, wherein each of said one or more reagent ports are fluidically connected to a reagent container.

4. The valve apparatus of claim 1, wherein each of said one or more input ports are fluidically connected to a unique bioprocessing device.

5. The valve apparatus of claim 1, wherein each of said one or more output ports are fluidically connected to a unique bioprocessing device.

6. The valve apparatus of claim 1, wherein said fluid received from said bioprocessing device comprises waste fluid, wherein said third manifold further comprises a drain port configured to remove said waste fluid from said valve apparatus.

7.-8. (canceled)

9. The valve apparatus of claim 1, wherein said first manifold is located above said second manifold, and wherein said second manifold is located above said third manifold.

10. The valve apparatus of claim 1, wherein said second manifold further comprises one or more access holes configured to couple to a pump, wherein said access holes are fluidically connected to said one or more fluid channels.

11. The valve apparatus of claim 10, wherein a first access hole of said one or more access holes is configured to couple to a first pump, and wherein a second access hole of said one or more access holes is configured to couple to a second pump.

12. The valve apparatus of claim 11, wherein said first access hole is fluidically connected to a first fluid channel of said one or more fluid channels, and wherein said second access hole is fluidically connected to a second fluid channel of said one or more fluid channels.

13. The valve apparatus of claim 12, wherein when in said second open position, (i) said first fluid channel is fluidically connected to an input port of said one or more input ports, and (ii) said second fluid channel is fluidically connected to an output port of said one or more input ports.

14. The valve apparatus of claim 1, wherein said first manifold, said second manifold, and said third manifold are circular in shape.

15. The valve apparatus of claim 14, wherein: (i) each of said one or more reagent ports are located at an equal distance from a center of said first manifold, (ii) each of said one or more input ports are located at an equal distance from a center of said third manifold, or (iii) each of said one or more output ports are located at an equal distance from a center of said third manifold.

16.-20. (canceled)

21. The valve apparatus of claim 1, wherein when in said first closed position, said one or more reagent ports are fluidically sealed from said one or more fluid channels.

22. The valve apparatus of claim 21, wherein said first manifold comprises a first alignment notch, and wherein said second manifold comprises a second alignment notch.

23. The valve apparatus of claim 22, wherein when in said first open position, said first alignment notch and said second alignment notch align with each other.

24. The valve apparatus of claim 1, wherein when in said second closed position, said one or more input ports or said one or more output ports are fluidically sealed from said one or more fluid channels.

25. The valve apparatus of claim 24, wherein said second manifold comprises a second alignment notch, and wherein said third manifold comprises a third alignment notch.

26. The valve apparatus of claim 25, wherein when in said second open position, said second alignment notch and said third alignment notch align with each other.

27. The valve apparatus of claim 1, wherein said second manifold further comprises a sterilization fluid port, and wherein said sterilization fluid port is configured to receive a sterilization fluid configured to sterilize interior surfaces of said valve apparatus.

28.-81. (canceled)
